(19) United States
(12) Patent Application Publication
(10) Pub. No.: US 2002/0025781 A1
(43) Pub. Date: Feb. 28, 2002

(54) Information distribution system using local radio network

(75) Inventor: Takeshi Saito, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOSHIBA, Minato-ku (JP)

(21) Appl. No.: 09/942,622

(22) Filed: Aug. 31, 2001

(30) Foreign Application Priority Data
Aug. 31, 2000 (JP) 2000-262482

(51) Int. Cl. H04B 5/00

(52) U.S. Cl. 455/41; 455/465

(57) ABSTRACT

An information distribution system is formed by a portable terminal, a local server for providing a local information which is accessible through a local radio network, and a subscription server for carrying out a membership subscription procedure which is accessible through a public network. When a terminal ID received from the portable terminal along with an access request is not registered in a membership database, the local server sends a server access membership subscription guidance for urging the portable terminal to carry out a membership subscription procedure. The portable terminal then sends a server access membership subscription request to the subscription server so as to carry out the membership subscription procedure.

### BACKGROUND OF THE INVENTION

1. Field of the Invention

The present invention relates to an information distribution system using a local radio network such as Bluetooth.

2. Description of the Related Art

The rapid spread of the portable telephones has drastically changed user's way of utilizing telephone and information retrieval. In both regards, there is now an environment in which telephone and information retrieval can be utilized any time anywhere, without limitations such as that it can be utilized by being “in front of a public telephone or a telephone at home/office” or “in front of a PC”. In particular, regarding the information retrieval, the realization of the so called “radio Internet” such as a service called “i-mode” by NTT Mobile Communications Network Inc. of Japan had the decisive impact.

Meanwhile, such a “radio Internet” still continues to advance. For example, the current “i-mode” service utilizes packet networks on the public telephone network as its infrastructure so that there are limitations such as its low speed access. Also, regardless of whether an information to be accessed is a location information or a remote information, it has been necessary for the user to pay both the communication fee and the information fee to the communication carrier. In particular, in the case where the information to be accessed is a local one (such as information on goods, etc., of a shop where the user is currently located, for example), it is desirable for the user to be able to minimize the communication fee to be paid to the communication carrier.

For this reason, there are propositions of the information providing service using a local area network. For example, there is a scheme for accessing local information by using a portable telephone which is also equipped with an interface for a local area network (local radio network such as Bluetooth).

On the other hand, there are demands from those who provide such local information (such as shops) for acquiring data on customers. Namely, just providing information for free in response to all requesting portable telephones only has limited merits to those who provide that information, and there are demands from the local information providing side for realizing more convenient systems in which an information fee can be charged for the information provided through the local radio network or the information can be provided only with respect to registered members.

### BRIEF SUMMARY OF THE INVENTION

It is therefore an object of the present invention to provide a portable terminal, a local radio server and a subscription server for realizing the information distribution system using a local radio network.

According to one aspect of the present invention there is provided a portable terminal in an information distribution system using a local server accessible through a local radio network and a subscription server accessible through a public network, portable terminal comprising: a local radio network interface configured to access the local server through the local radio network; a public network interface configured to access the subscription server through the public network; a local server access request unit configured to send an access request for a local information provided by the local server, to the local server through the local radio network, along with a terminal ID for identifying the portable terminal; and a membership subscription request unit configured to send a server access membership subscription request through the public network to an address of the subscription server described in a server access membership subscription guidance for urging the portable terminal to carry out a membership subscription procedure which is returned from the local server when the access request is rejected by the local server.

According to another aspect of the present invention there is provided a local server in an information distribution system using a portable terminal accessible to the local server through a local radio network and a subscription server accessible through a public network, the local server comprising: a local radio network interface configured to be accessed from the portable terminal through the local radio network; a public network interface configured to carry out communications with the subscription server through the public network; a local information storage configured to store a local information; a local information access request receiving unit configured to receive an access request for the local information stored in the local information storage, along with a terminal ID for identifying the portable terminal, from the portable terminal through the local radio network; a membership database configured to register in advance terminal IDs of those portable terminals which have server access membership; a membership checking unit configured to check whether the terminal ID received along with the access request is registered in the membership database or not; a membership subscription guidance sending unit configured to send a server access membership subscription guidance for urging the portable terminal to carry out a membership subscription procedure, to the portable terminal through the local radio network, when the terminal ID received along with the access request is not registered in the membership database; and a membership database updating unit configured to receive a new membership information from the subscription server through the public network and update the membership database according to the new membership information.

According to another aspect of the present invention there is provided a subscription server in an information distribution system using a portable terminal accessible to the subscription server through a public network and a local server for providing a local information which is accessible through a local radio network, the subscription server comprising: a public network interface configured to carry out communications with the portable terminal or the local server through the public network; a membership subscription request receiving unit configured to receive a server access membership subscription request for accessing the local server, from the portable terminal or the local server through the public network; a membership subscription procedure processing unit configured to carry out a membership subscription procedure in response to the server access membership subscription request; and a notification unit configured to notify information on the portable terminal to the local server through the public network when the server access membership subscription request is accepted by the membership subscription procedure.

Other features and advantages of the present invention will become apparent from the following description taken in conjunction with the accompanying drawings.

### BRIEF DESCRIPTION OF THE DRAWINGS

FIG. 1 is a schematic diagram showing an exemplary configuration of the information distribution system according to the present invention.

FIG. 2 is a block diagram showing an exemplary internal configuration of a portable terminal in the information distribution system of FIG. 1.

FIG. 3 is a block diagram showing an exemplary internal configuration of a Bluetooth base station in the information distribution system of FIG. 1.

FIG. 4 is a block diagram showing an exemplary internal configuration of a subscription server in the information distribution system of FIG. 1.

FIG. 5 is a sequence chart for an exemplary processing sequence according to the first embodiment of the present invention.

FIG. 6 is a sequence chart for an exemplary processing sequence according to the second embodiment of the present invention.

FIG. 7 is a sequence chart for an exemplary processing sequence according to the third embodiment of the present invention.

### DETAILED DESCRIPTION OF THE INVENTION

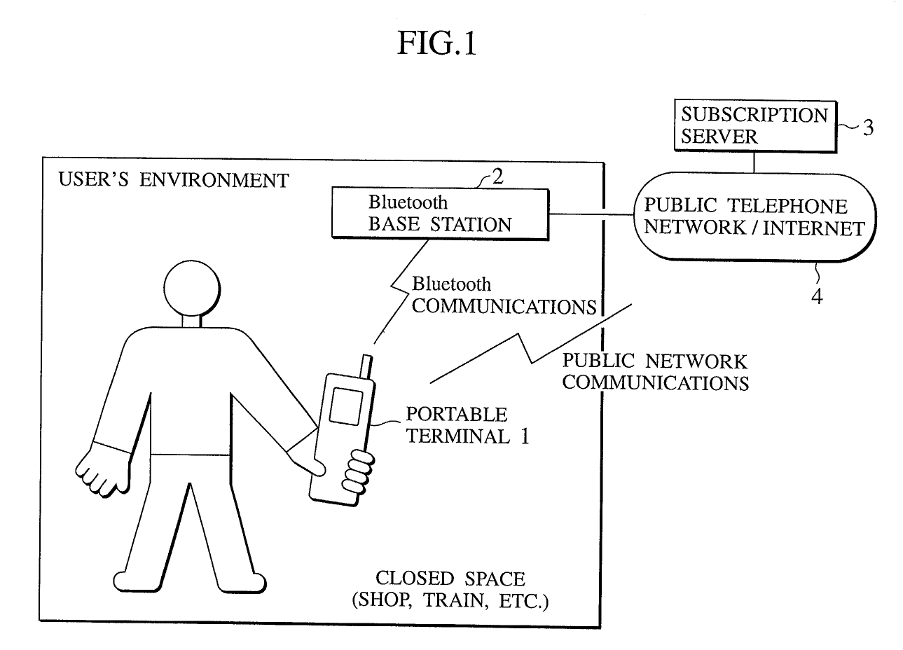

Referring now to FIG. 1 to FIG. 5, the first embodiment of an information distribution system according to the present invention will be described in detail.

FIG. 1 shows an exemplary configuration of the information distribution system in this embodiment under a user's environment for utilizing a portable terminal. In the environment shown in FIG. 1, the user is located in some closed space such as that of a shop, a theme park, a hall, a train, a bus, etc. As shown in FIG. 1, the user has a portable terminal 1 which is equipped with two communication interfaces, one for the Bluetooth and one for a public network (a public telephone network, for example).

The information distribution system of FIG. 1 also includes a Bluetooth base station 2 located within the closed space and a subscription server 3 located outside the closed space, which are connected through a public telephone network/Internet 4.

Here, the Bluetooth is a kind of the radio LAN characterized by its low cost and low power consumption, which is expected to be implemented in many portable terminals (see documents available at “http://www.bluetooth.com” for further details).

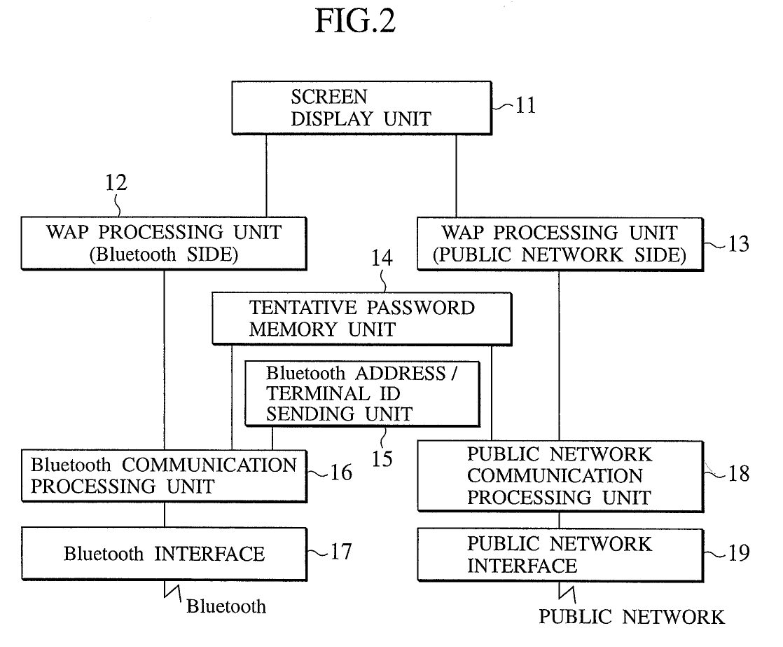

FIG. 2 shows an exemplary internal configuration of the portable terminal 1, which comprises a screen display unit 11, a WAP processing unit (Bluetooth side) 12, a WAP processing unit (public network side) 13, a tentative password memory unit 14, a Bluetooth address/terminal ID sending unit 15, a Bluetooth communication processing unit 16, a Bluetooth interface 17, a public network communication processing unit 18 and a public network interface 19.

This portable terminal 1 of the user can receive the communication service by selectively utilizing the Bluetooth communications and the public network communications according to time, place and occasion.

The Bluetooth base station 2 is a base station provided at a location where general public gathers such as an interior of a train or a bus, a shop or a museum, a train station's platform or gate, a concert hall, etc., for providing information (especially local information, such as a transfer information or a time table information in the case of a train or a bus, a goods information or a discount information in the case of a shop, or more general information such as news, weather forecast, traffic or accident information, etc.) with respect to the portable terminal 1 of the user through the Bluetooth communications.

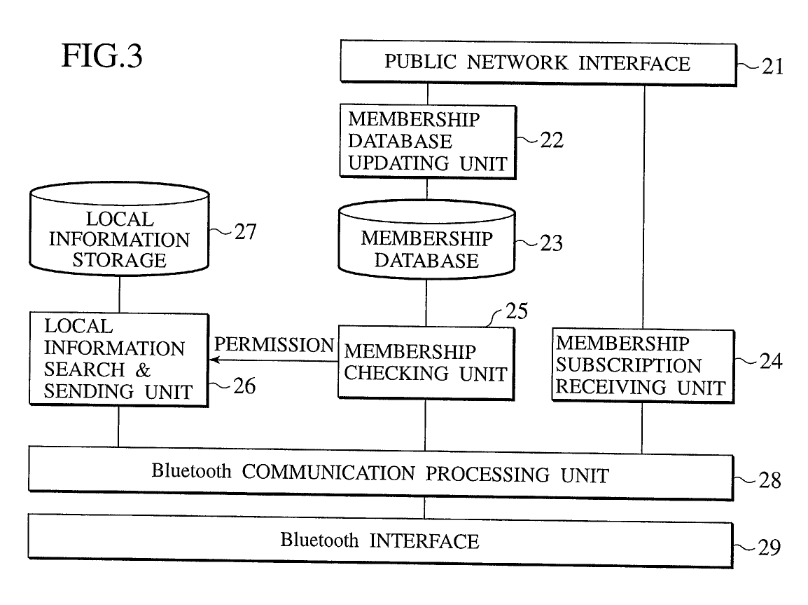

FIG. 3 shows an exemplary internal configuration of the Bluetooth base station 2, which comprises a public network interface 21, a membership database updating unit 22, a membership database 23, a membership subscription receiving unit 24, a membership checking unit 25, a local information search and sending unit 26, a local information storage 27, a Bluetooth communication processing unit 28 and a Bluetooth interface 29.

The Bluetooth base station 2 is connected to the public telephone network/Internet 4 through the public network interface 21 so as to carry out the information updating for the local information storage 27 from the public telephone network/Internet 4 side, the updating of the membership database 23, and processing requiring communications with the public telephone network/Internet 4 (such as the membership subscription procedure that requires communications with the subscription server 3 on the public telephone network/Internet 4) as will be described in detail below.

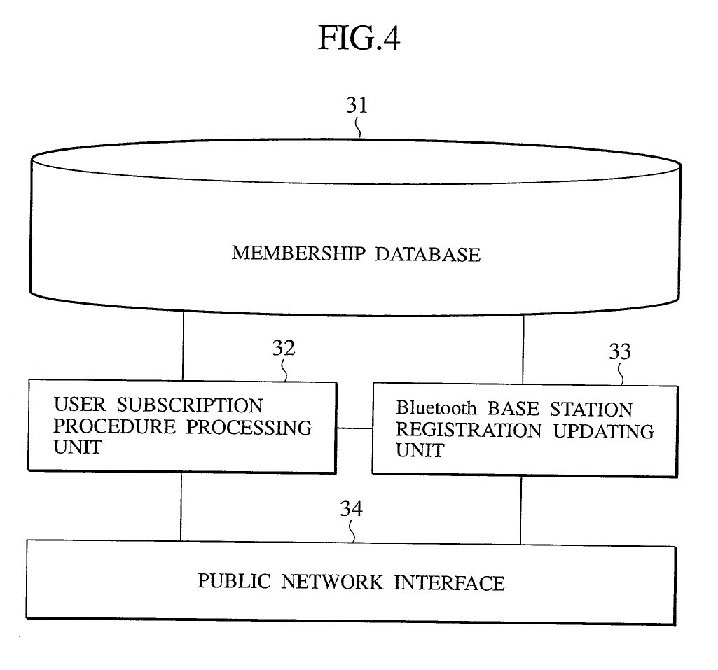

FIG. 4 shows an exemplary internal configuration of the subscription server 3, which comprises a membership database 31, a user subscription procedure processing unit 32, a Bluetooth base station registration updating unit 33, and a public network interface 34.

As can be seen from the configuration of FIG. 2, the information providing with respect to the portable terminal 1 is to be carried out through WAP (Wireless Application Protocol) in this embodiment, both for the Bluetooth and the public network, but in practice it is possible to use any other suitable information description format such as XML, HTML, C(Compact)HTML, etc.

Now, in the environment shown in FIG. 1, the user can acquire the desired information stored in the local information storage 27 of the Bluetooth base station 2, through the Bluetooth base station 2. Here, however, the acquisition of the information is based on the membership system so that only those users who are registered members can acquire the information. Namely, the information providing service is offered only with respect to the portable terminals which are registered at the membership database 23 in the Bluetooth base station 2 in principle. It is still possible to incorporate any desired combination of various other service styles such as trial service, free service, etc., into the information distribution system of this embodiment. A procedure for the membership registration to be carried out in this regard will now be described in detail.

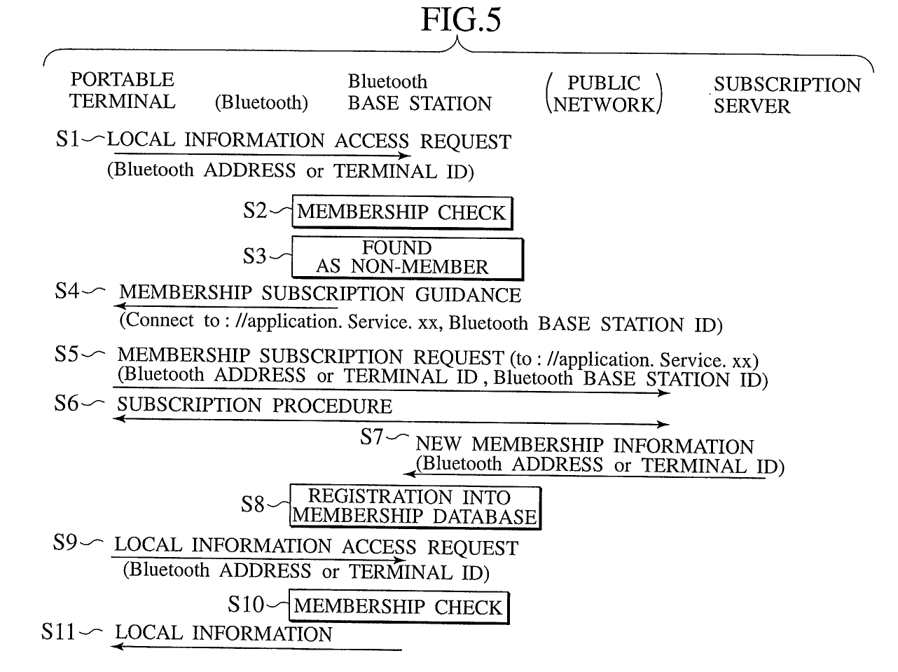

FIG. 5 shows an exemplary processing sequence in the first embodiment. First, the portable terminal 1 sends a local information access request to the Bluetooth base station 2 (step S1). At this point, a terminal ID which is an ID for uniquely identifying the portable terminal 1 (such as a Bluetooth address, a public network address such as a portable telephone number or the like, a terminal ID assigned to a built-in IC card or IC card application of the portable terminal 1, etc.) is sent along with the local information access request.

Upon receiving this request, the Bluetooth base station 2 carries out a processing for checking whether the portable terminal 1 as identified by the notified terminal ID is a member who can receive the local information providing service or not (step S2). More specifically, the membership checking unit 25 refers to the membership database 23 and checks whether this terminal ID is registered as the member or not. Here, it is assumed that this terminal ID is not registered in the membership database 23 and found as a non-member at this stage (step S3). Then, the Bluetooth base station 2 sends a membership subscription guidance to (the user of) this portable terminal 1 (step S4) so as to inform that the membership subscription is necessary in order to receive this service. This membership subscription guidance is also transmitted by the WAP. In the processing sequence of FIG. 5, “application.Service.xx is an address (URL) of a site on the public network at which this membership subscription can be made.

In this guidance, it is also possible to attach an ID of the Bluetooth base station 2. This ID can be useful in the case involving a plurality of Bluetooth base stations 2 that provide the similar services, in such a way that it becomes easier for a server that manages these services (which is the subscription server 3 in this embodiment) to find out which Bluetooth base station is a target of the subscription procedure. Up to this point, all the communications are taking place on the Bluetooth, so that the communication fee that will be required when the public network is utilized has not been incurred at all.

Upon receiving this guidance, (the user of) this portable terminal 1 refers to this membership subscription guidance and sends a membership subscription request to the subscription server 3 on the public network (the address “application.Service.xx”) through the public telephone network/Internet 4 (step S5). At this point, the terminal ID and the Bluetooth base station ID described above are also sent along this request. Subsequently, the necessary subscription procedure (such as input of a name and a point of contact, checking of the membership policy, payment of the membership fee, etc.) is carried out between the portable terminal 1 and the subscription server 3 through the public telephone network/Internet 4 (step S6).

When the subscription procedure is completed in this way, the subscription server 3 notifies the fact that the portable terminal 1 with this terminal ID has newly become a member, to the Bluetooth base station 2 through the public telephone network/Internet 4 (step S7). Here, the notification to the Bluetooth base station 2 may be made in such a manner that the subscription server 3 judges “which Bluetooth base station should be notified first” and notifies that Bluetooth base station at higher priority. Alternatively, this notification may be made simultaneously (or sequentially) with respect to a plurality of Bluetooth base stations.

Upon receiving this notification, the Bluetooth base station 2 registers the notified terminal ID into the membership database 23 through the membership database updating unit 22 (step S8). Also, before or after that, the fact that the membership subscription is completed may be notified to the portable terminal 1.

Then, the portable terminal 1 sends the local information access request along with the terminal ID, to the Bluetooth base station 2 again (step S9). This time, the Bluetooth base station 2 checks that this terminal ID is registered in the membership database 23 (step S10) and sends the requested local information to the portable terminal 1 (step S11).

In this way, the portable terminal 1 can become a member who can receive the information distribution provided by the Bluetooth base station 2. The subscription server 3 that manages the membership can be located at a headquarters of the convenience store chain, for example, so as to manage the information distribution members of all the convenience stores, while the Bluetooth base station 2 can be located at each store for the purpose of carrying out the information distribution within that store. There is no need to provide the subscription server 3 at each store so that the considerable reduction of cost is possible.

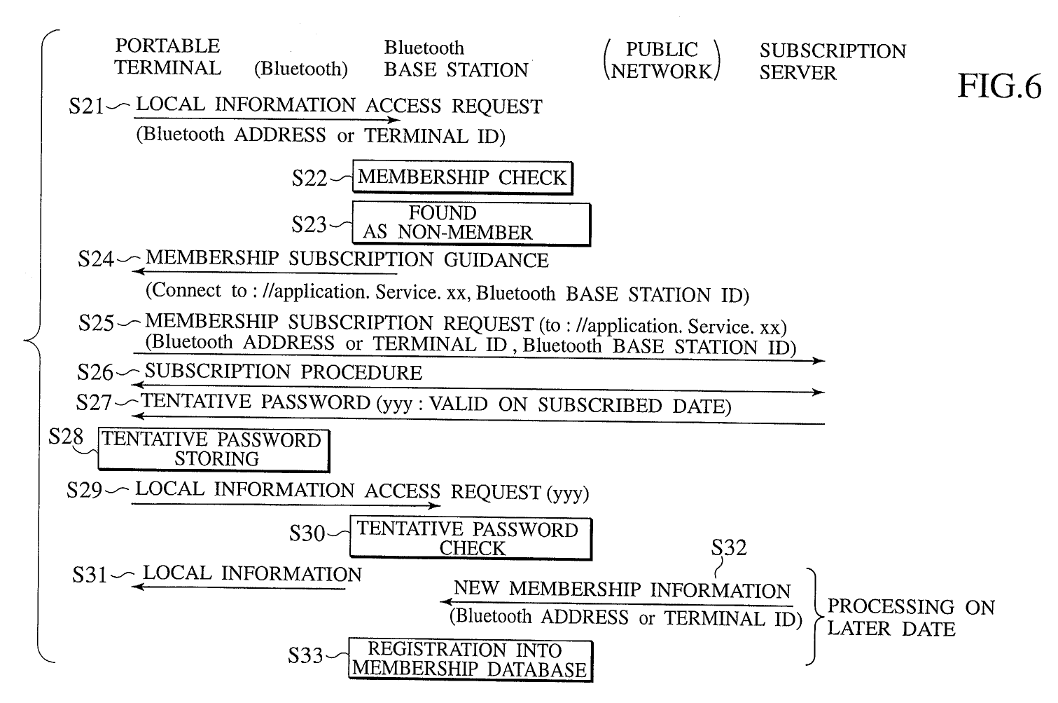

Referring now to FIG. 6, the second embodiment of an information distribution system according to the present invention will be described in detail.

In this embodiment, the information distribution system has the configuration similar to that shown in FIG. 1. Also, the portable terminal 1 has the configuration similar to that shown in FIG. 2, the Bluetooth base station 2 has the configuration similar to that shown in FIG. 3, and the subscription server 3 has the configuration similar to that shown in FIG. 4.

The first embodiment described above presupposes the environment in which the Bluetooth base station 2 and the subscription server 3 are always connected through the public telephone network/Internet 4 so that the membership database 23 can be updated in real time (immediately after the membership subscription procedure). However, when the Bluetooth base station is located in a train or a bus, for example, there can be cases where the membership database 23 in the Bluetooth base station 2 cannot be updated immediately. This second embodiment is directed to such cases.

FIG. 6 shows an exemplary processing sequence in the second embodiment. Similarly as in the first embodiment, first, the portable terminal 1 sends a local information access request to the Bluetooth base station 2 (step S21). At this point, a terminal ID which is an ID for uniquely identifying the portable terminal 1 (such as a Bluetooth address, a public network address such as a portable telephone number or the like, a terminal ID assigned to a built-in IC card or IC card application of the portable terminal 1, etc.) is sent along with the local information access request.

Upon receiving this request, the Bluetooth base station 2 carries out a processing for checking whether the portable terminal 1 as identified by the notified terminal ID is a member who can receive the local information providing service or not (step S22), and it is assumed that this terminal ID is found as a non-member at this stage (step S23). Then, the Bluetooth base station 2 sends a membership subscription guidance containing an address for making the membership subscription, to (the user of) this portable terminal 1 (step S24) so as to inform that the membership subscription is necessary in order to receive this service. In this guidance, it is also possible to attach an ID of the Bluetooth base station 2.

Upon receiving this guidance, (the user of) this portable terminal 1 refers to this membership subscription guidance and sends a membership subscription request to the subscription server 3 on the public network (the address “application.Service.xx”) through the public telephone network/Internet 4 (step S25). At this point, the terminal ID and the Bluetooth base station ID described above are also sent along this request. Subsequently, the necessary subscription procedure (such as input of a name and a point of contact, checking of the membership policy, payment of the membership fee, etc.) is carried out between the portable terminal 1 and the subscription server 3 through the public telephone network/Internet 4 (step S26).

When the subscription procedure is completed in this way, the subscription server 3 recognizes that the new membership information cannot be registered into this Bluetooth base station 2 immediately according to the value of the Bluetooth base station ID, and sends a tentative password (“yyy”) to the portable terminal 1 (step S27). This password may be one that is dedicatedly assigned to that Bluetooth base station 2. Here. the user of the portable terminal 1 may or may not directly recognize this password, depending on the way of operating the system. This tentative password should preferably has a suitable valid period corresponding to the time required by the subscription server 3 to register the new membership information into the Bluetooth base station 2, such that it is valid only on the subscribed date (the day of the subscription), for example. The portable terminal 1 stores this tentative password into the tentative password memory unit 14 (step S28).

Then, the portable terminal 1 sends the local information access request by attaching the tentative password (“yyy”) described above, to the Bluetooth base station 2 again (step S29). In this case, the Bluetooth base station 2 checks the tentative password (step S30), and as long as it is still within the valid period of the tentative password, the Bluetooth base station 2 accepts this access request and provides the requested local information to the portable terminal 1 (step S31).

Before or after that (and preferably within the valid period of the tentative password), the subscription server 3 notifies the fact that the portable terminal 1 with this terminal ID has newly become a member, to the Bluetooth base station 2 through the public telephone network/Internet 4 (step S32). Upon receiving this notification, the Bluetooth base station 2 registers the notified terminal ID into the membership database 23 through the membership database updating unit 22 (step S33). If this registration is completed within the valid period of the tentative password, it is possible to access the request from the portable terminal 1 even after the valid period of the tentative password expires.

This second embodiment is particularly effective in the case where the closed space is a moving closed space such as that of a train or a bus. Namely, there can be cases where it is difficult to update the membership database 23 in the Bluetooth base station 2 immediately after the subscription is made at the subscription server 3 (such as cases where the public network is temporarily inaccessible at that moving closed space or cases where the communication cost is high while moving). In such cases, this embodiment can enable the information providing service after a prescribed time has elapsed, so that the information providing service can be realized without exerting any stress on the user.

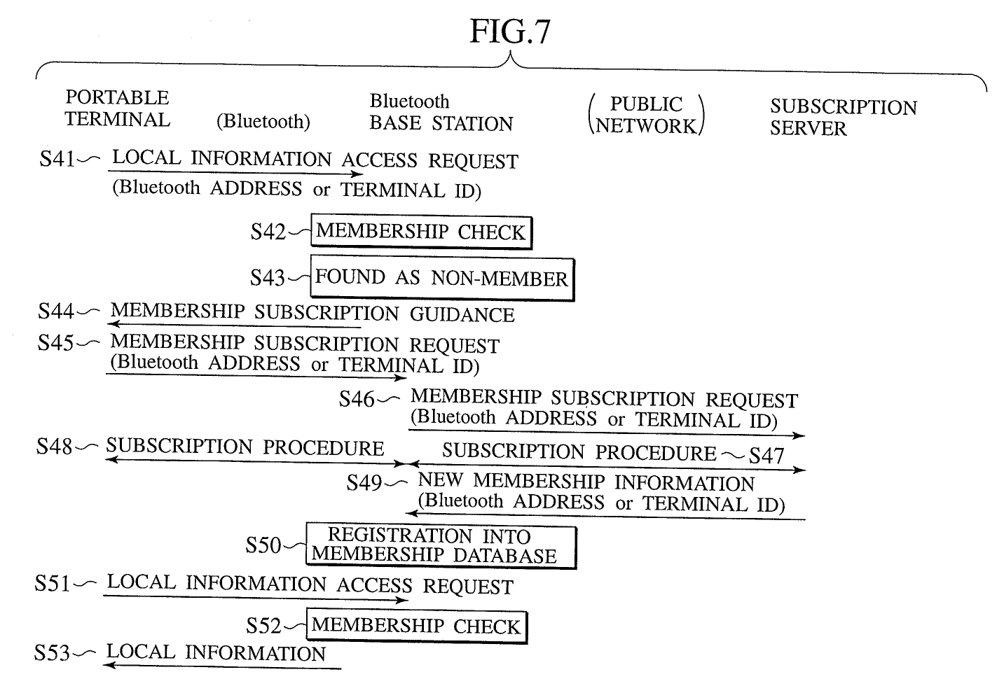

Referring now to FIG. 7, the third embodiment of an information distribution system according to the present invention will be described in detail.

In this embodiment, the information distribution system has the configuration similar to that shown in FIG. 1. Also, the portable terminal 1 has the configuration similar to that shown in FIG. 2, the Bluetooth base station 2 has the configuration similar to that shown in FIG. 3, and the subscription server 3 has the configuration similar to that shown in FIG. 4.

The first embodiment described above is directed to the case where the portable terminal 1 has two communication interfaces for the Bluetooth communications and the public network communications, and the actual membership subscription procedure is carried out through the public network. This scheme has drawbacks in that it is difficult to accept the subscription from locations where the communications with the public network are impossible (such as inside an underground street or a tunnel, for example), and that the communication fee for the public network will be incurred by the membership subscription. This third embodiment is directed to the case where the membership subscription procedure can also be carried out through the Bluetooth communications.

FIG. 7 shows an exemplary processing sequence in the third embodiment. First, the portable terminal 1 sends a local information access request to the Bluetooth base station 2 (step S41). At this point, a terminal ID which is an ID for uniquely identifying the portable terminal 1 (such as a Bluetooth address, a public network address such as a portable telephone number or the like, a terminal ID assigned to a built-in IC card or IC card application of the portable terminal 1, etc.) is sent along with the local information access request.

Upon receiving this request, the Bluetooth base station 2 carries out a processing for checking whether the portable terminal 1 as identified by the notified terminal ID is a member who can receive the local information providing service or not (step S42), and it is assumed that this terminal ID is found as a non-member at this stage (step S43). Then, the Bluetooth base station 2 sends a membership subscription guidance to (the user of) this portable terminal 1 (step S44) so as to inform that the membership subscription is necessary in order to receive this service. Here, the site at which this membership subscription can be made is basically this Bluetooth base station 2 itself.

Upon receiving this guidance, (the user of) this portable terminal 1 sends a membership subscription request along with the terminal ID to the Bluetooth base station 2 (step S45). At the Bluetooth base station 2, when this request is recognized as the membership subscription request, the membership subscription receiving unit 24 receives this request, and forwards it to the subscription server 3 which is a server on the public network for carrying out the actual membership subscription procedure, after applying the necessary protocol conversion or format conversion (step S46). Subsequently, the necessary subscription procedure is carried out between the portable terminal 1 and the subscription server 3 through the membership subscription receiving unit 24 of the Bluetooth base station 2 as a gateway (steps S47 and S48).

When the subscription procedure is completed in this way, the subscription server 3 notifies the fact that the portable terminal 1 with this terminal ID has newly become a member, to the Bluetooth base station 2 through the public telephone network/Internet 4 (step S49). Upon receiving this notification, the Bluetooth base station 2 registers the notified terminal ID into the membership database 23 through the membership database updating unit 22 (step S50). Also, before or after that, the fact that the membership subscription is completed may be notified to the portable terminal 1.

Then, the portable terminal 1 sends the local information access request along with the terminal ID, to the Bluetooth base station 2 again (step S51). This time, the Bluetooth base station 2 checks that this terminal ID is registered in the membership database 23 (step S52) and sends the requested local information to the portable terminal 1 (step S53).

As described, according to the present invention, it is possible to provide a portable terminal, a local radio server and a subscription server for realizing the information distribution system using a local radio network.

Note that, in the above embodiments, there can be cases where there is a need to collect the membership fee in conjunction with the use of the membership system, and in such cases, the membership fee can be charged by utilizing the charging system of the portable telephone public network carrier (communication carrier), for example.

Note also that, in the above embodiments, it is assumed that the Bluetooth base station 2 and the subscription server 3 are connected through the public network, but the present invention is also applicable to the cases where the Bluetooth base station 2 and the subscription server 3 are connected through a dedicated line, a VPN (Virtual Private Network), or a local area network when the Bluetooth base station 2 and the subscription server 3 are located within the same physical location.

It is also to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. A portable terminal in an information distribution system using a local server accessible through a local radio network and a subscription server accessible through a public network, portable terminal comprising:
a local radio network interface configured to access the local server through the local radio network;
a public network interface configured to access the subscription server through the public network;
a local server access request unit configured to send an access request for a local information provided by the local server, to the local server through the local radio network, along with a terminal ID for identifying the portable terminal; and
a membership subscription request unit configured to send a server access membership subscription request through the public network to an address of the subscription server described in a server access membership subscription guidance for urging the portable terminal to carry out a membership subscription procedure which is returned from the local server when the access request is rejected by the local server.

2. The portable terminal of claim 1, wherein the membership subscription request unit sends the server access membership subscription request along with a local server ID attached to the server access membership subscription guidance.

3. The portable terminal of claim 1, further comprising:
a tentative password memory unit configured to store a tentative password with a limited valid period which is given from the subscription server in response to the server access membership subscription request;
wherein the local server access request unit sends another access request for the local information provided by the local server, along with the tentative password stored in the tentative password memory unit, after receiving the tentative password from the subscription server in response to the server access membership subscription request.

4. The portable terminal of claim 1, further comprising:
an information processing unit configured to process the local information received from the local server in response to the access request.

5. A local server in an information distribution system using a portable terminal accessible to the local server through a local radio network and a subscription server accessible through a public network, the local server comprising:
a local radio network interface configured to be accessed from the portable terminal through the local radio network;
a public network interface configured to carry out communications with the subscription server through the public network;
a local information storage configured to store a local information;
a local information access request receiving unit configured to receive an access request for the local information stored in the local information storage, along with a terminal ID for identifying the portable terminal, from the portable terminal through the local radio network;
a membership database configured to register in advance terminal IDs of those portable terminals which have server access membership;
a membership checking unit configured to check whether the terminal ID received along with the access request is registered in the membership database or not;
a membership subscription guidance sending unit configured to send a server access membership subscription guidance for urging the portable terminal to carry out a membership subscription procedure, to the portable terminal through the local radio network, when the terminal ID received along with the access request is not registered in the membership database; and
a membership database updating unit configured to receive a new membership information from the subscription server through the public network and update the membership database according to the new membership information.

6. The local server of claim 5, wherein the membership subscription guidance sending unit sends the server access membership subscription guidance along with an address of the subscription server for carrying out a membership subscription procedure.

7. The local server of claim 5, wherein the membership subscription guidance sending unit sends the server access membership subscription guidance along with a local server ID for identifying the local server on the public network.

8. The local server of claim 5, further comprising
a local information sending unit configured to send the local information to the portable terminal through the local radio network in response to the access request when the terminal ID received along with the access request is registered in the membership database.

9. The local server of claim 5, further comprising:
a local information sending unit configured to send the local information to the portable terminal through the local radio network when the access request is received along with a tentative password with a limited valid period.

10. The local server of claim 9, wherein the membership database updating unit updates the membership database within the limited valid period of the tentative password.

11. The local server of claim 5, further comprising:
a membership subscription request relaying unit configured to receive a server access membership subscription request from the portable terminal through the local radio network, and forward the server access membership subscription request to the subscription server through the public network.

12. A subscription server in an information distribution system using a portable terminal accessible to the subscription server through a public network and a local server for providing a local information which is accessible through a local radio network, the subscription server comprising:
a public network interface configured to carry out communications with the portable terminal or the local server through the public network;
a membership subscription request receiving unit configured to receive a server access membership subscription request for accessing the local server, from the portable terminal or the local server through the public network;
a membership subscription procedure processing unit configured to carry out a membership subscription procedure in response to the server access membership subscription request; and
a notification unit configured to notify information on the portable terminal to the local server through the public network when the server access membership subscription request is accepted by the membership subscription procedure.

13. The subscription server of claim 12, wherein the information distribution system uses a plurality of local servers, the membership subscription request receiving unit receives the server access membership subscription request along with a local server ID of one local server, that is returned from said one local server to the portable terminal along with a membership subscription guidance for urging the portable terminal to carry out the membership subscription procedure in response to the access request, and the notification unit notifies the information on the portable terminal to said one local server as identified by the local server ID.

14. The subscription server of claim 12, wherein the information distribution system uses a plurality of local servers, and the notification unit notifies the information on the portable terminal to the plurality of local servers.

15. The subscription server of claim 12, wherein the membership subscription procedure processing unit gives a tentative password with a limited valid period to the portable terminal in response to the server access membership subscription request.
